(19) United States
(12) Patent Application Publication
(10) Pub. No.: US 2013/0109368 A1
(43) Pub. Date: May 2, 2013

(54) METHODS AND DEVICES FOR SUPPORTING STATE RECONFIGURATION OF USER EQUIPMENTS

(71) Applicant: Bo Hellander, Taby (SE)

(72) Inventor: Bo Hellander, Taby (SE)

(73) Assignee: TELEFONAKTIEBOLAGET L M ERICSSON (publ), Stockholm (SE)

(21) Appl. No.: 13/375,066

(22) PCT Filed: Oct. 27, 2011
(86) PCT No.: PCT/SE11/51276

§ 371 Date: Nov. 29, 2011

(51) Int. Cl. H04W 4/00

(52) U.S. Cl. 455/418

(57) ABSTRACT

A User Equipment (UE) is reconfigured to a state of a Radio Resource Control (RRC) state machine. The reconfigured UE informs the network not only that a current data session is completed, but also of the expected time to a next data session and/or the expected traffic volume for the next data session. In this way, the network has better information on which to base resource-related decisions.

### TECHNICAL FIELD

The technology relates to signalling connection release indication procedures. More specifically, it relates to methods in Radio Access Networks and in User Equipments for supporting reconfiguration of User Equipments, a device in the Radio Access Network, and a User Equipment UE comprising a module for supporting reconfiguration of a User Equipment.

### BACKGROUND

A signalling connection release indication procedure is used by a User Equipment, UE, to indicate to the Radio Access Network, RAN, that one of its signalling connections has been released or to request the RAN to initiate a state transition to a more battery efficient and less resource consuming Radio Resource Control, RRC, state, see Ref [1].

The Radio Resource Control protocol belongs to the UMTS WCDMA (Universal Mobile Telecommunications System Wideband Code Division Multiple Access) protocol stack and handles the control plane signalling of Layer 3 between the UE and the RAN, e.g. a Universal Terrestrial RAN, UTRAN. The RRC protocol includes:
Functions for connection establishment and release;
Broadcast of system information;
Radio Bearer establishment/reconfiguration and release;
RRC connection mobility procedures;
Paging notification and release;
Outer loop power control.

Further, a typical WCDMA network implementation involves inactivity timers. The configuration of inactivity timers has considerable impact on the battery life of a mobile UE when a packet data connection is open. The RRC idle mode, i.e. no connection, has the lowest energy consumption.

FIG. 3 is a diagram schematically illustrating the power resource consumption at different states in the RRC connected mode and RRC idle mode.

The states in the RRC connected mode, in order of decreasing resource consumption, are CELL_DCH (Dedicated Channel), CELL_FACH (Forward Access Channel), CELL_PCH (Cell Paging Channel) and URA_PCH (URA Paging channel). In the following, CELL_PCH and URA_PCH will be considered as equivalent states, and the notation CELL/URA_PCH could be used hereafter when the CELL_PCH and URA_PCH state is discussed. The power consumption in the CELL_FACH may be roughly 50 percent of that in CELL_DCH, and the PCH states use about 1-2 percent of the power consumption of the CELL_DCH state. The transitions of lower resource consuming states occur when inactivity timers trigger. A timer T1 controls transition from CELL_DCH to CELL_FACH, a timer T2 controls transition from CELL_FACH to CELL/URA_PCH, and a timer T3 controls transition from CELL/URA_PCH to IDLE.

The RRC connection is defined as a point-to-point bi-directional connection between RRC peer entities in the UE and the UTRAN. A UE has either zero or one RRC connection.

The signalling connection is defined as a point to point bi-directional connection between peer entities in the UE and the core network. There can be one signalling connection for each of the Packet Switched and Circuit Switched core networks.

An RRC Signalling Connection Release Indication message is used by the UE to indicate to UTRAN the release of an existing signalling connection. If a data session from the UE is completed, the UE takes a decision that the session is completed and sends an end-of-session message, i.e. a Signalling Connection Release Indication message to the Radio Network Control, RNC, of the UTRAN. The message comprises a cause value, which the UE is configured to set to “UE requested PS Data session end” for indicating to the UTRAN that current data session is completed and that the UE would like to be reconfigured to a dormant state, i.e. a more battery efficient state, see Ref [2].

A Radio Network Control node of the UTRAN may be adapted to reconfigure the RRC state machine from the state CELL_DCH to one of the more battery efficient states, either CELL_FACH, CELL_PCH, URA_PCH or IDLE. There is a resource cost in both radio network and core network for setting up a new connection from IDLE mode, and there is also a resource cost in the radio network for transitions between the different RRC connected mode states. Every change of state incurs a cost. Setting up a new connection also takes a significant time. It is not efficient from a UE battery consumption point of view if a UE is reconfigured from IDLE to connected mode more or less directly after the UE has been released to the IDLE mode state.

### SUMMARY

It is an object to provide a method that provide better optimization of resource consumption, such as UE battery consumption, radio resource usage and network resource usage, e.g. signalling resources, processing resources, hardware resources, than known methods.

The object is achieved by letting the UE inform the network, e.g., a Radio Network Control node, not only that the current data session is completed, but also of the expected time to next data session and the expected traffic volume for the next data session. In this way the network has better information on which to base resource-related decisions and to select a suitable state for the UE between the data sessions.

Another object is to avoid unnecessary signalling over the air interface between the UE and a RAN as well as between RAN and core network.

Example embodiments for achieving these and other objects are provided. The example embodiments, performed in a Radio Access Network, support reconfiguration of a User Equipment, UE, to a state of a Radio Resource Control state machine. Information concerning the UE's next data session is received in a message indicating the end of a data session performed by the UE. The embodiments may also comprise selecting a state for the UE based on the information concerning the UE's next data session and a selection rule set.

Further, the embodiments comprise generating a message indicating the end of a data session performed by the UE and sending the message to the Radio Access Network where the UE is residing. The generation of the message comprises inserting information concerning the UE's next data session in the message.

Device embodiments comprise a receiver to receive information concerning the UE's next data session in a message for indicating the end of a data session performed by the UE. The device embodiments further comprise a selecting module configured to select a state for the UE based on the information concerning the UE's next data session and a selection rule set.

Additionally, a module for a User Equipment and embodiments thereof are also provided. This module and embodiments are adapted to support reconfiguration to a state of a Radio Resource Control state machine of the UE. The module and its embodiments comprise a message generator to generate a message indicating the end of a data session performed by the UE, and a sender to send the message to a node of the Radio Access Network where the UE is residing. The message generator comprises an insert module configured to insert information concerning the UE's next data session in said message.

A User Equipment comprising the above described module and embodiments thereof is also provided.

One advantage is that the provided methods, devices, modules, user equipment and embodiments thereof provide a possibility to optimize usage of battery power, radio resources, and network resources more efficiently.

### BRIEF DESCRIPTION OF THE DRAWINGS

The foregoing, and other, objects, features and advantages will be more readily understood upon reading the following detailed description in conjunction with the drawings in which:

FIG. 1 is a block diagram of an exemplary network in which entities, systems and methods described herein may be implemented;

FIG. 2 is a signalling scheme showing the signalling between a User Equipment UE and a Radio Access Network RAN;

FIG. 3 is a diagram schematically illustrating the power resource consumption at different states;

FIG. 4a is a diagram schematically illustrating the principle of reconfiguration decisions and state selections according to some example embodiments;

FIG. 4b is a diagram schematically illustrating the principle of a reconfiguration decision and state selection according to an example of a selection rule;

FIG. 4c is a diagram schematically illustrating the principle of a reconfiguration decision and state selection according to an example of a selection rule;

FIG. 4d is a diagram schematically illustrating the principle of a reconfiguration decision and state selection according to an example of a selection rule;

FIG. 4e is a diagram schematically illustrating the principle of a reconfiguration decision and state selection according to an example of a selection rule;

FIG. 5 is a flowchart illustrating some embodiments of a method for supporting reconfiguration of a User Equipment UE;

FIG. 6A and FIG. 6B are flowcharts illustrating further embodiments of a method for supporting reconfiguration of a User Equipment UE;

FIG. 7 is a flowchart illustrating further some embodiments of a method for supporting reconfiguration of a User Equipment UE;

FIG. 8 is a block diagram illustrating embodiments of a node of a Radio Access Network, said node comprising a device for supporting reconfiguration of a User Equipment UE;

FIG. 9 is a block diagram illustrating embodiments of a module in a User Equipment UE.

### DETAILED DESCRIPTION

In the following description, for purposes of explanation and not limitation, specific details are set forth, such as particular circuits, circuit components, techniques, etc. in order to provide a thorough understanding of the provided methods and devices. In other instances, detailed descriptions of well known methods, devices, and circuits are omitted so as not to obscure the description of the present embodiments with unnecessary detail. However, it will be apparent to one skilled in the art how the present described embodiments may be practiced.

Further, the terms reconfigure, reconfiguring, reconfiguration, etc, are used in the description and claims. However, the terms configure, configuring, configuration may as well be used. Said wordings should be considered as mutually equivalent and non-limiting.

In the following detailed description, a message indicating the end of a data session performed by the UE is denoted end-of-session message. Further, a message comprising information about a selected state is denoted a reconfiguration order message.

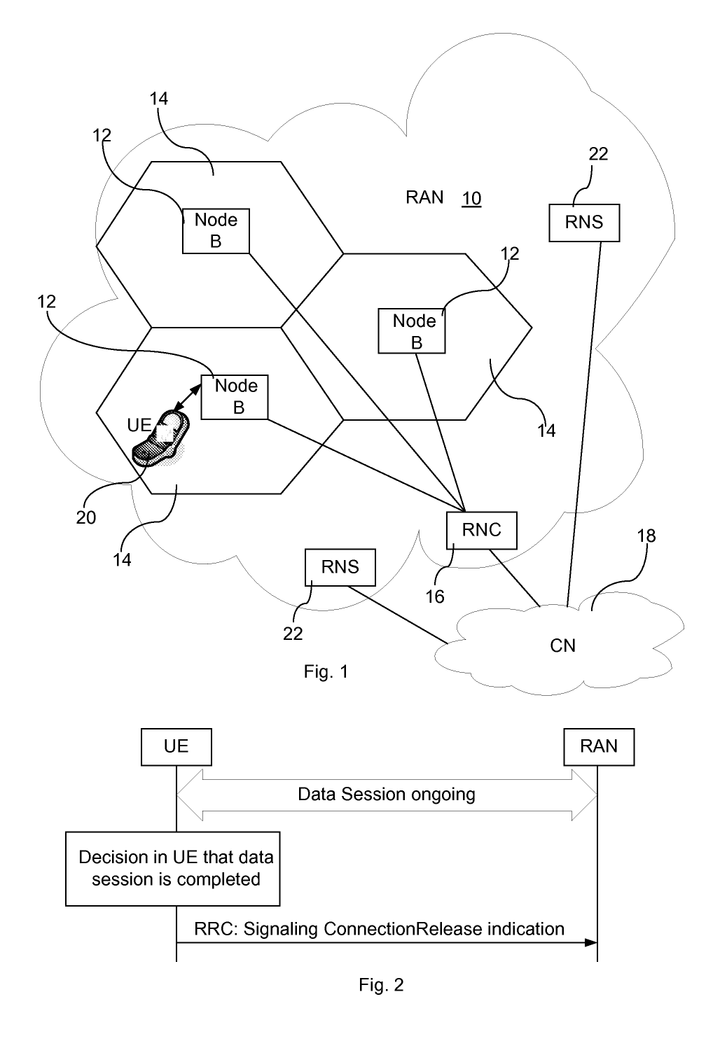

FIG. 1 illustrates an exemplary network in which embodiments of methods and devices described herein may be implemented.

The drawing illustrates a Radio Access Network, RAN, 10 comprising at least one, in this example three, Radio Network Subsystems, RNSs, 22 comprising a number of Node Bs, or Radio Base Stations, 12 connected to and controlled by a Radio Network Controller, RNC, 16. The RNC 16 is connected to a Core Network, CN, 18 for receiving and transmitting data and telecommunications traffic from other network systems. The RNC controls the Node Bs using the Node B Application Protocol, NBAP. Each Node B 12 is an access node for providing wireless radio communication access for User Equipments, UEs, 20 via an air interface within an area, i.e., cell 14. Different standards may be used, e.g., 2G, 3G, etc. In the drawing, one UE 20 is illustrated. The UE has an ongoing data session over the air interface and via the Node B in the cell where it is for the moment residing.

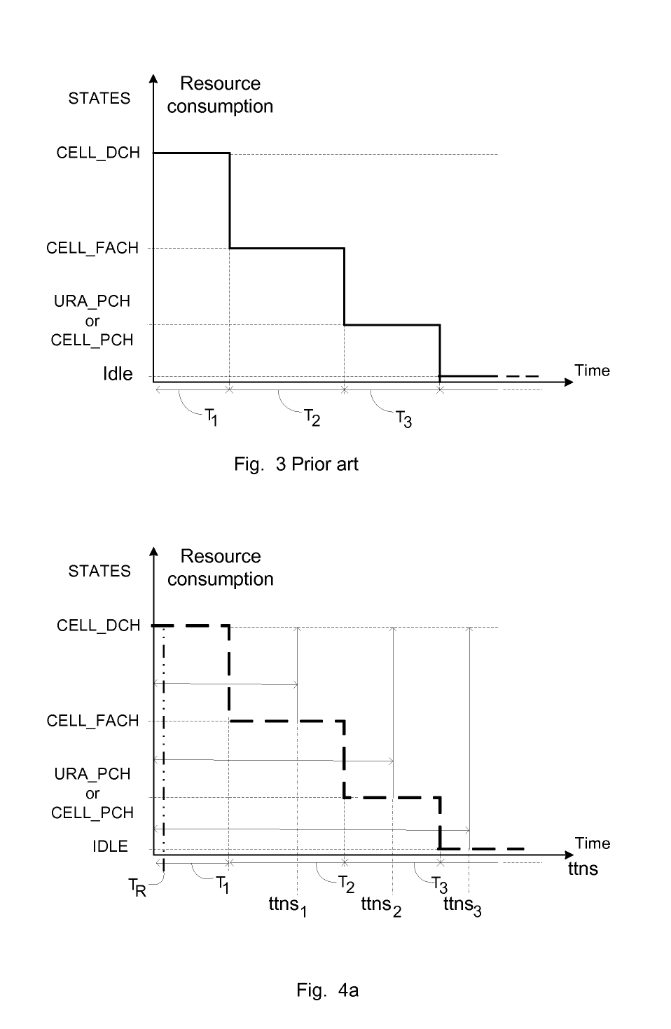

FIG. 2 is a signalling scheme showing the signalling between a User Equipment UE and a Node, typically a Radio Network Controller RNC, in a Radio Access Network, RAN.

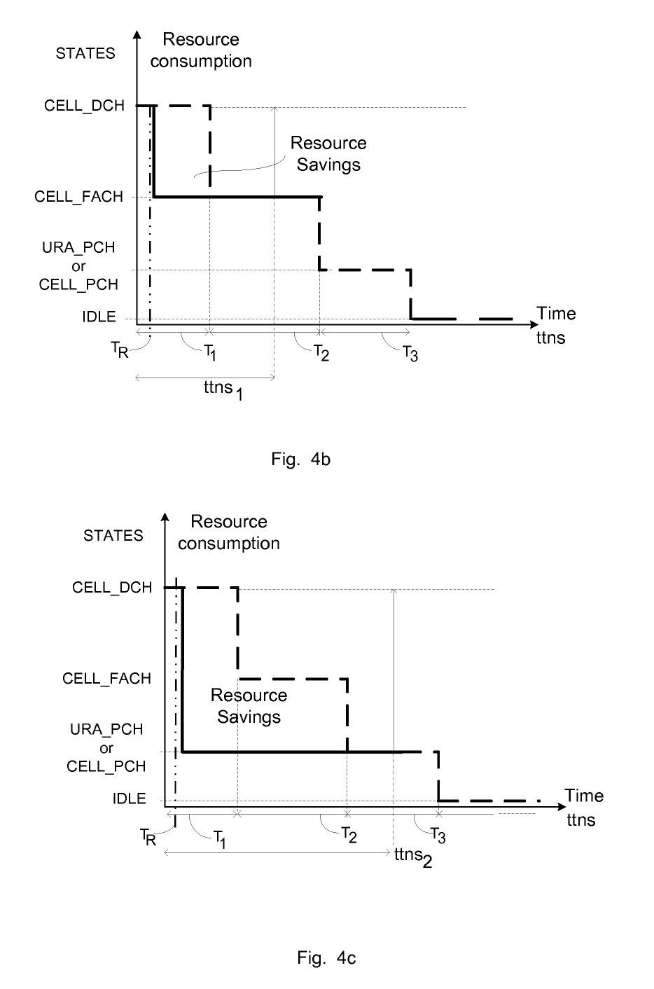

The figure illustrates that a data session is ongoing between a UE and a RAN to which the UE for the moment is connected. The UE then takes a decision that the session is completed, and it therefore sends an end-of-session message, such as a Signalling Connection Release Indication message to the RAN. According to current standards in the field, the end-of-session message does not comprise any information regarding next data session. The RAN receives the message, and after a certain time period, the RNC of the RAN releases the connection with the UE, the connection being a Dedicated Channel, DCH. Thus, the RNC changes the state of its state machine, which in the following is described with reference to FIG. 3.

FIG. 3 is a diagram schematically illustrating the power resource consumption at different states used, already described in the Background section of this specification. The RNC is adapted to reconfigure its state machine from the state CELL_DCH to one of the more energy saving states, either CELL/URA_PCH or IDLE mode state, triggered by the received end-of-session message. If a data session ends at t=0, a transition from CELL_DCH to CELL_FACH state is set to T₁, CELL_FACH to CELL/URA_PCH is set to T₁+T₂ and CELL/UAR_PCH to IDLE mode is set to T₁+T₂+T₃ respectively is effectuated at user inactivity. As indicated, the inactive UE is configured to stay in a state for a certain time period, e.g. T₁, T₂ and T₃. As seen in FIG. 3, the state transitions constitute a staircase where each step corresponds to a certain state during a period of time. Thus, state CELL_DCH lasts during period T₁, state CELL_FACH lasts during period T₂. and state CELL/URA_PCH lasts during period T₃. After T₁+T₂+T₃, the UE is set in the IDLE mode state.

As the time for setting up a new Radio Access Bearer is considerable, it may not be an energy saving if an UE is reconfigured from Idle to connected mode more or less directly after the UE been released to the IDLE state.

One object is to provide a better energy saving method. The UE informs the network, e.g., the Radio Network Control node, not only that the current data session is completed, but also of the expected time to next data session and the expected traffic volume for the next data session. In this way, the network has better information on which to base resource-related decisions and select a suitable state for the UE between the data sessions.

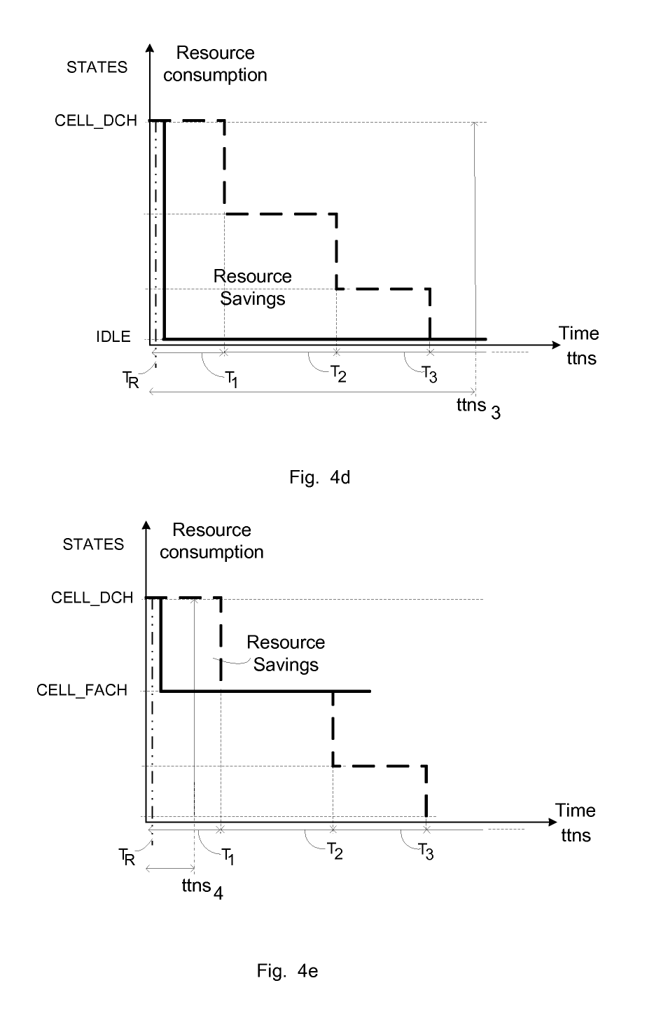

By introducing two new information elements, “expected time to next session”, abbreviated ttns and “expected data volume for next session”, abbreviated dvns, in an end-of-session message, e.g. the RRC Signalling Connection Release Indication message, the network receives better information to base its decisions on when selecting if the UE shall be hosted in CELL_DCH, CELL_FACH or CELL/URA_PCH or released to IDLE as illustrated in FIGS. 4a-4e.

By introduction of the two new information elements, “expected time to next session” and “expected data volume for next session” in an end-of-session message, better information is provided for selection of which state to host the UE in. For a network decision, some embodiments use a selection rule set comprising a timer rule set and/or a data volume rule set. A timer rule set comprises at least one timer rule, and a data volume rule set comprises at least one data volume rule. The rules may be pre-defined, preferably by the operator of the network. In the following, a few examples of timer rules and data volume rules will be described and discussed in relation to the example illustrated in FIGS. 4a-4e.

FIG. 4a is a diagram schematically illustrating a principle of reconfiguration decisions and states selections according to some example embodiments. This figure shows two things:

(1) The stair of state transitions, see fat dashed line, that take place for an inactive UE not requesting fast dormancy compare with FIG. 3; and

(2) The principle of reconfiguration decisions and state selections according to the selection rule set.

Further, the time T_{R} is indicating the time for the reception of an end-of-session message. Different values of the parameter ttns, expected time to next session, are indicated as ttns₁, ttns₂, ttns₃.

These rules may be defined as following examples:
Timer rule: If ttns<T1, then stay on state CELL_DCH. This timer rule controls the RNC to decide and select the current state for the UE's state machine.
Timer rule: If T₁≦ttns<T₁+T₂, then select state CELL_FACH. This timer rule controls the RNC to decide and select the CELL_FACH state for the UE's state machine if ttns=ttns₁. The effect of this rule is illustrated in FIG. 4b.

If the received ttns value is between T₁+T₂ and T₁+T₂+T₃, e.g. ttns=ttns₂, the network is configured to select one state, e.g. CELL/URA_PCH, for the state machine of the UE. The rule may therefore be defined as follows:
Timer rule: If T₁+T₂≦ttns<T₁+T₂+T₃, then select state CELL/URA_PCH.

The effect of this rule is illustrated in FIG. 4c.

If the received ttns value is situated after T₁+T₂+T₃, e.g. ttns=ttns₃, the network is configured to select one state, e.g. Idle, for the state machine of the UE. Thus, the UE is released. The rule may therefore be defined as follows:
Timer rule: If T1+T2+T₃≦ttns, then select the IDLE state. The effect of this rule is illustrated in FIG. 4d.

Further, data volume rules may be defined. Data volume dvns is here the total amount of user data to be transferred during the next data session. A data volume threshold may be defined as dvnsₜ, and if the received dvns value is less or equal to dvnsₜ, the network is configured to select a less resource consuming state, e.g. CELL_FACH, even if the timer rule alone indicates a more resource consuming state, e.g. CELL_DCH, for the state machine of the UE. The selection rule set may therefore be defined as a combination of a timer rule and a data volume rule:
If ttns<T1 and dyns≦dynsₜ, then select the CELL_FACH state. The effect of said rule is illustrated in FIG. 4e.

In FIGS. 4b-4e, the stair of state transitions in FIG. 3 is indicated by a fat dashed line, while the UE's selected state before and after the state transition is indicated by a continuous fat line. During some periods of time, the UE is in a state less energy consuming compared to the state stair case in FIG. 3 (see dashed line), and there will be an area between the dashed line and the between the two lines. That area is a measure of the amount of saved energy.

FIG. 4b is a diagram schematically illustrating an example of reconfiguration decisions and states selections when the expected time to next session ttns is set to ttns₁, wherein T₁≦ttns₁<T₁+T₂. The state transition is performed by the UE when it has received a reconfiguration order message comprising the information about the selected state. The time T_{R} is indicating the time for the reception of the end-of-session message. The UE's selected state before and after the state transition is indicated by a continuous fat line. Compared to the state transition according to FIG. 3, indicated by the fat dashed line, the faster transition into a more energy efficient state will result in savings of resources, here indicated as the area between the fat dashed line at Cell_DCH and the fat line at CELL_FACH. A transition to CELL_DCH will not occur until the UE request the RAN and RNC for a dedicated channel.

FIG. 4c is a diagram schematically illustrating an example of reconfiguration decisions and states selections when the expected time to next session ttns is set to ttns₂, wherein T₁+T₂≦ttns₂<T₁+T₂+T₃. The state transition is performed by the UE when it has received a reconfiguration order message comprising the information about the selected state. The time T_{R} is indicating the time for the reception of the end-of-session message. The UE's selected state before and after the state transition is indicated by a continuous fat line. Compared to the state transition according to FIG. 3, indicated by the fat dashed line, the faster transition into a more energy efficient state will result in savings of resources, here indicated as the area between the fat dashed line at Cell_DCH via CELL_FACH and the fat line at CELL/URA_PCH. A transition to CELL_DCH will not occur until the UE requests the RAN and RNC for a dedicated channel. A transition to CELL_DCH will not occur until the UE requests the RAN and RNC for a dedicated channel.

FIG. 4d is a diagram schematically illustrating an example of reconfiguration decisions and states selections when the expected time to next session ttns is set to ttns₃, wherein T₁+T₂+T₃≦ttns₃. The state transition is performed by the UE when it receives a reconfiguration order message comprising the information about the selected state. The time T_{R} is indicating the time for the reception of the end-of-session message. The UE's selected state before and after the state transition is indicated by a continuous fat line. Compared to the state transition according to FIG. 3, indicated by the fat dashed line, the faster transition into a more energy efficient state will result in savings of resources, here indicated as the area between the fat dashed line at Cell_DCH via CELL_FACH and CELL/URA_PCH and the fat line at IDLE. A transition to CELL_DCH will not occur until the UE requests the RAN and RNC for a dedicated channel. A transition to CELL_DCH will not occur until the UE requests the RAN and RNC for a dedicated channel.

FIG. 4e is a diagram schematically illustrating an example of reconfiguration decisions and states selections when the expected time to next session ttns is set to ttns₄, wherein ttns₄<T₁. The selection rule set is defined as a combination of a timer rule and a data volume rule:
If ttns<T1 and dyns≦dynsₜ, then select the CELL_FACH state.

The state transition is performed by the UE when it has received a reconfiguration order message comprising the information about the selected state. The time T_{R} is indicating the time for the reception of the end-of-session message. The UE's selected state before and after the state transition is indicated by a continuous fat line. Compared to the state transition according to FIG. 3, indicated by the fat dashed line, the faster transition into a more energy efficient state will result in savings of resources, here indicated as the area between the fat dashed line at Cell_DCH and the fat line at CELL_FACH. A transition to CELL_DCH will not occur until the UE requests the RAN and RNC for a dedicated channel.

In FIG. 4b, the resource saving area is smaller compared to that in FIG. 4c, which is smaller than the area between the fat lines in FIG. 4d. These figures show that significant energy resources are saved by introducing the two new information elements, “expected time to next session” and “expected data volume for next session” in an end-of-session message, thereby providing better information for selection of which state to host the UE using the selection rule set comprising a timer rule set and/or a data volume rule set.

So far in this description, example embodiments and aspects have been described using four states, i.e., CELL_DCH, CELL_FACH, CELL/URA_PCH, and IDLE states. In the following, example embodiments and aspects are described using generalized states S1, S2, S3 . . . , SN, the states organized in order of decreasing resource consumption.

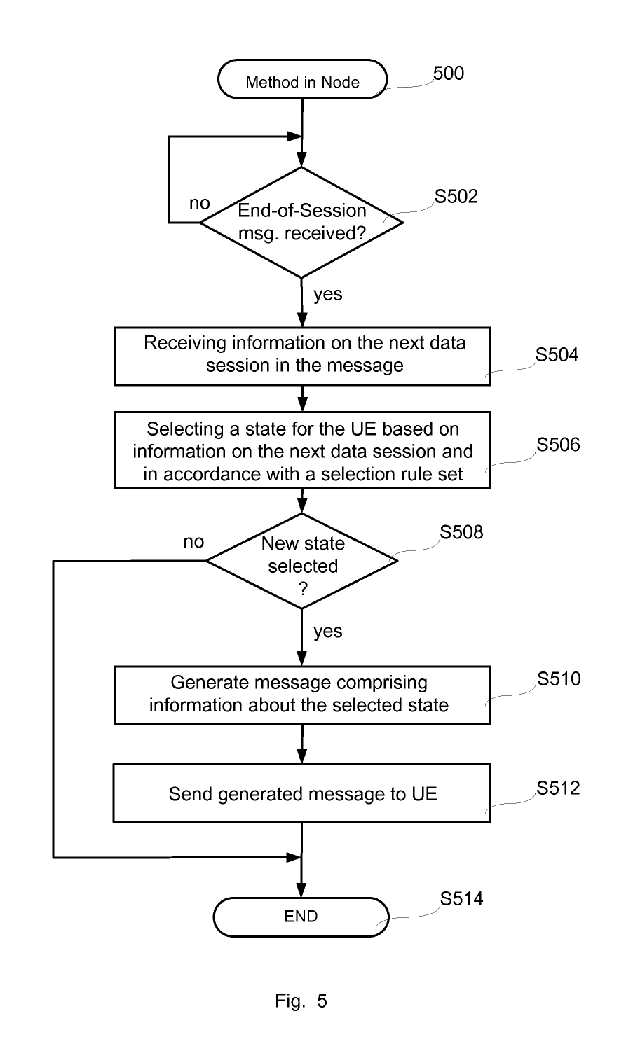

FIG. 5 is a flowchart illustrating embodiments of a method in a node 16 (see FIG. 1) of a Radio Access Network 10 (see FIG. 1) for supporting reconfiguration of a User Equipment UE to a state S1, S2, . . . , of a Radio Resource Control, RRC, state machine.

The method comprises:
S502: The method starts when an end-of-session message from a connected UE is received (yes) by the node. During the data session, the node may be adapted to wait for said end-of-session message, indicated as a waiting loop, indicated as a (no)-branch.
S504: Receiving information on the UE's next data session in the message, e.g. an end-of-session message. The information on the UE's next data session may comprise information indicating an expected time to next session, ttns, of the UE and/or information indicating an expected data volume of next session, dvns, of the UE. The end-of-session message may be a Signal Connection Release Indication (SCRI) Message.
S506: Selecting a state S1, S2, . . . , for the UE based on the information on the next data session and in accordance with a selection rule set. The selection rule set comprises a predefined timer rule set configured for selecting a state S1, S2, . . . , of the RRC state machine based on information, e.g. a parameter value, indicating an expected time to next session, ttns, for the UE. The selection rule set may also comprise a predefined data volume rule set configured for selecting a state S1, S2, . . . , of the RRC state machine based on information, e.g. a parameter value, indicating an expected data volume of next session, duns, for the UE. The decision and selection of states to reconfigure to by means of selection rule sets may be performed as described in the examples of FIGS. 4a-4e above.
   If the received ttns value, i.e. expected time to next session, is situated between T₁ and T₁+T₂, e.g. ttns=ttns₁, the network is configured to select one state, e.g. S2, for the state machine of the UE. The rule may therefore be defined as follows:
Timer rule: If T₁≦ttns<T₁+T₂, then select state S2.
   If the received ttns value is situated between T₁+T₂ and T₁+T₂+T₃, e.g. ttns=ttns₂, the network is configured to select one state, e.g. S3, for the state machine of the UE. The rule may therefore be defined as follows:
Timer rule: If T₁+T₂≦ttns<T₁+T₂+T₃, then select state S3.
   If the received ttns value is situated after T₁+T₂+T₃, e.g. ttns=ttns₃, the network is configured to select one state, e.g. IDLE, for the state machine of the UE. Thus, the UE is released. The rule may therefore be defined as follows:
Timer rule: If T₁+T₂+T₃≦ttns, then select state S4.
   Further, data volume rules may be defined. A data volume threshold may be defined as dvnsₜ, and if the received duns value is less or equal to dv₁, the network is configured to select one state, e.g. S2, for the state machine of the UE. If the received dvns value is exceeding dvnsₜ, the network is configured to select another state, e.g. S1.
S508: If a new state for the UE is selected (yes), the method is adapted to generate a reconfiguration order message, see S510. If a new state for the UE is not selected (no), the method is adapted to proceed to the end, see S514. The UE may then remain in its present state.
S510: Generate message comprising information about the selected state. A reconfiguration order message comprising the selected state is generated as a result of the positive test in S508.
S512: Send generated message to UE. The reconfiguration order message comprising the selected state is sent to the UE.
S514: When the reconfiguration order message has been sent to the UE the method is completed.

States S1, S2 . . . may correspond to CELL_DCH, CELL_FACH or CELL/URA_PCH or IDLE, which states are illustrated in FIGS. 4a-4e.

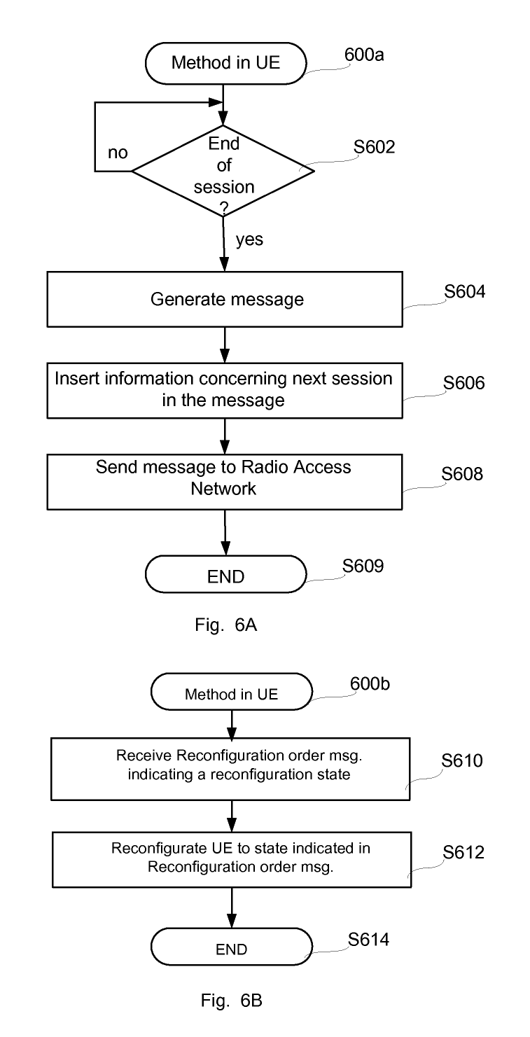

FIG. 6A and FIG. 6B are flowcharts illustrating some aspects of a method for supporting reconfiguration of a User Equipment UE to a state S1, S2 . . . of a Radio Resource Control, RRC, state machine. The method is divided in two parts 600a, 600b, but both parts of the method take place in the UE. The first part 600a, which is illustrated in FIG. 6A, comprises:
S602: The method starts in the UE when a data session is completed between the UE and a Radio Network Control node of a Radio Access Network. During the data session, the UE may be adapted to wait for generating and sending an end-of-session message, indicated as a waiting loop, indicated as a (no)-branch
S604: Generate message. When a data session is completed, an end-of-session message is generated wherein the generation of the message comprises the sub-block S606.
S606: Inserting information concerning the UE's next data session in the message, i.e. end-of-session message. The information on the next data session comprises information indicating an expected time to next session, ttns, of the UE and/or information indicating an expected data volume of next session, duns, of the UE, and wherein ttns and duns may be the values of the parameters.
S608: Sending the message, i.e. end-of-session message, to the Radio Access Network for reception in one of the nodes of the network. The end-of-session message may be a Signal Connection Release Indication Message.
S609: The method stops.
The second part 600b of the method is illustrated in FIG. 6B. The part starts when the UE receives a reconfiguration order message and comprises:
S610: Receiving from the Radio Access Network a reconfiguration order message comprising a selected state for reconfiguring the UE.
S612: Reconfiguring the UE to the state S1, S2, . . . indicated in the reconfiguration order message. Thus, the UE may perform a state transition to the state indicated in the reconfiguration order message.
S614: The method stops.

States S1, S2, . . . , may correspond to CELL_DCH, CELL_FACH or CELL/URA_PCH or IDLE state, which are illustrated in FIGS. 4a-4e.

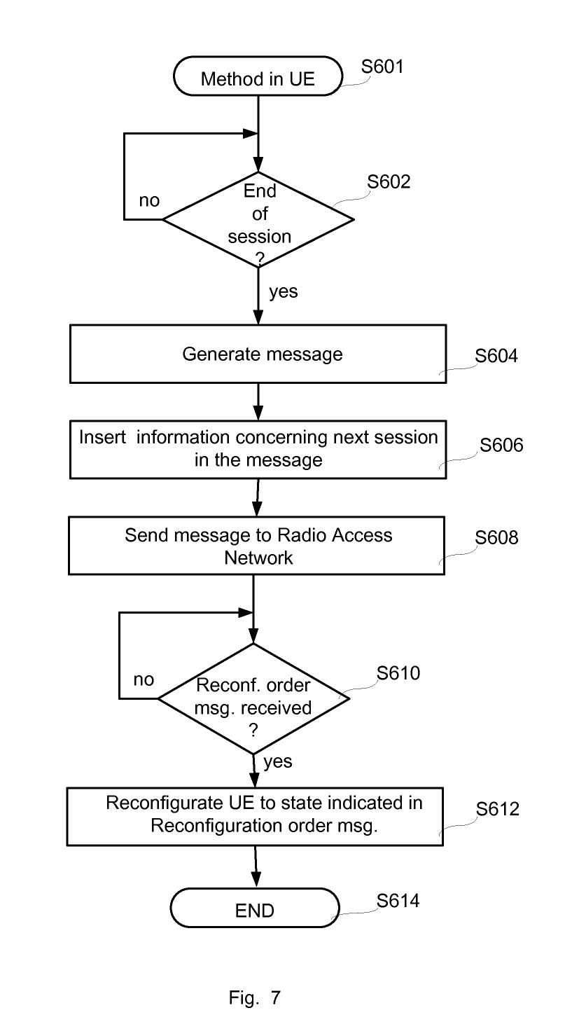

FIG. 7 is a flowchart illustrating some other embodiments of a method for supporting reconfiguration of a User Equipment UE to a state S1, S2, . . . , of a Radio Resource Control, RRC, state machine. This embodiment of the method is a combination of the two parts 600a, 600b, illustrated in FIGS. 6a and 6b. Thus, the two parts of the method taking place in the UE is united to one method. The difference between the two embodiments is that the stop block S609 is replaced by block S610, which is a waiting mode wherein the method waits for the reconfiguration order message from the network node. As soon as said message is received, S612 is performed, wherein the UE is reconfigured to the state S1, S2, . . . , indicated in the reconfiguration order message. after the reconfiguration, the method stops, S614.

Other aspects provide a Radio Access Network, comprising one or more nodes supporting reconfiguration of a User Equipment UE to a state S1, S2, . . . .

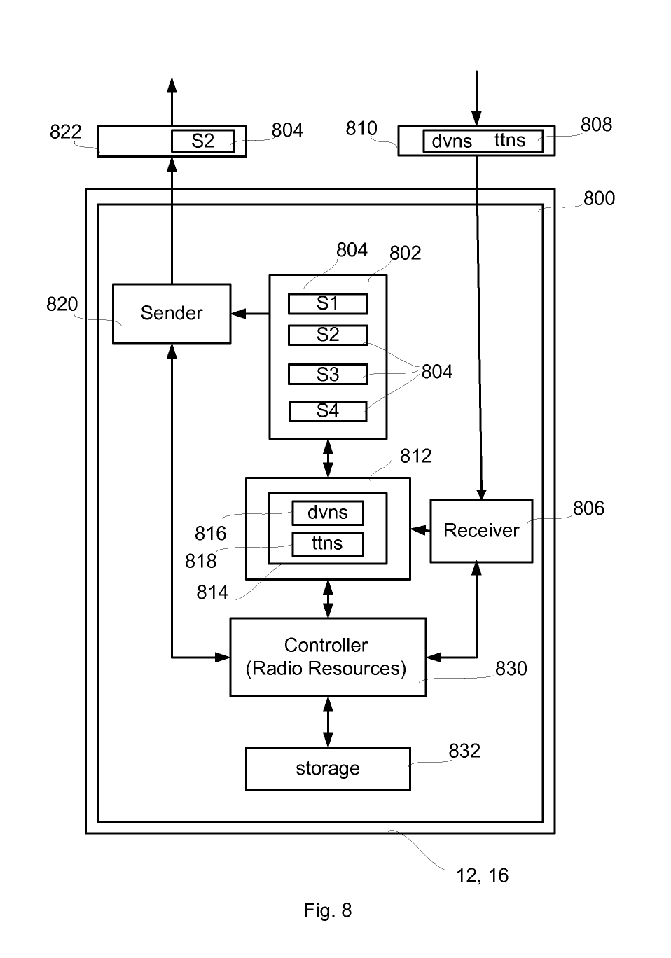

FIG. 8 is a block diagram illustrating a node 16 (see FIG. 1) of a Radio Access Network 10 (see FIG. 1), said node 16 comprising a device 800 for supporting reconfiguration of a User Equipment UE to a state S1, S2, . . . , of a Radio Resource Control, RRC, state machine, in accordance with the method 500 described with reference to FIG. 5.

The device 800 comprises a number of functional blocks of which some are shown in FIG. 8 and some are omitted so as not to obscure the description with unnecessary detail. In FIG. 8 is depicted a node device 800 comprising a receiver block 806, a sender block 820, a controller 830 and storage 832, a Radio Resource Control RRC state machine 802 and a selecting module 812.

As stated above in this description, a message indicating the end of a data session performed by the UE is denoted end-of-session message. Further, a message comprising information about the selected state is denoted reconfiguration order message.

The node 16 and its device 800 is configured to receive end-of-session messages 810 comprising information 808 on the next data session. Said information comprises information indicating an expected time to next session, ttns, of the UE, and/or information indicating an expected data volume of next session, duns, of the UE. The end-of-session message 810 may be a Signal Connection Release Indication Message.

The receiver 806 is configured to receive and extract said information 808 concerning the UE's next data session in an end-of-session message 810, and deliver the extracted information to a selecting module 812 configured to select the state S1, S2, . . . , for the UE based on the information 808 on a next data session and in accordance with a selection rule set 814. The selecting module 812 comprises the selection rule set 814 involving a predefined timer rule set 816 for selecting a state S1, S2, . . . , of the RRC state machine 802 based on the information indicating an expected time to next session, ttns, and/or on the information indicating an expected data volume of next session duns for the UE. The decision and selection of states to reconfigure to by means of selection rule sets may be performed as described in FIGS. 4a-4e above. If the received ttns value, i.e. expected time to next session, is situated between T₁ and T₁+T₂, e.g. ttns=ttns₁, the network is configured to select one state, e.g. S2, for the state machine of the UE. The rule may therefore be defined as follows:

Timer rule: If T₁≦ttns<T₁+T₂, then select state S2.

If the received ttns value is situated between T₁+T₂ and T₁+T₂+T₃, e.g. ttns=ttns₂, the network is configured to select one state, e.g. S3, for the state machine of the UE. The rule may therefore be defined as follows:

Timer rule: If T₁+T₂≦ttns<T₁+T₂+T₃, then select state S3.

If the received ttns value is situated after T₁+T₂+T₃, e.g. ttns=ttns₃, the network is configured to select one state, e.g. IDLE, for the state machine of the UE. Thus, the UE is released. The rule may therefore be defined as follows:

Timer rule: If T₁+T₂+T₃≦ttns, then select state S4.

Further, data volume rules may be defined. A data volume threshold may be defined as dvnsₜ, and if the received dvns value is less or equal to dvnsₜ, the network is configured to select one state, e.g. S2, for the state machine of the UE. If the received dvns value is exceeding dvnsₜ, the network is configured to select one state, e.g. S1.

The sender module 820 is adapted to send a reconfiguration order message 822 comprising information about the selected state 804 if a new state S1, S2, . . . , for the UE is selected, i.e. if a state reconfiguration for the UE is decided. The node may comprise other radio devices, processors and components, which are not shown in the figure. According to some embodiments, some elements or functional blocks of the device 800 may be common and shared by the node and the device 800, such as the sender, receiver and controller.

Further aspects are to provide a User Equipment UE adapted to support reconfiguration to a state (S1, S2 . . . ) of a Radio Resource Control, RRC, state machine.

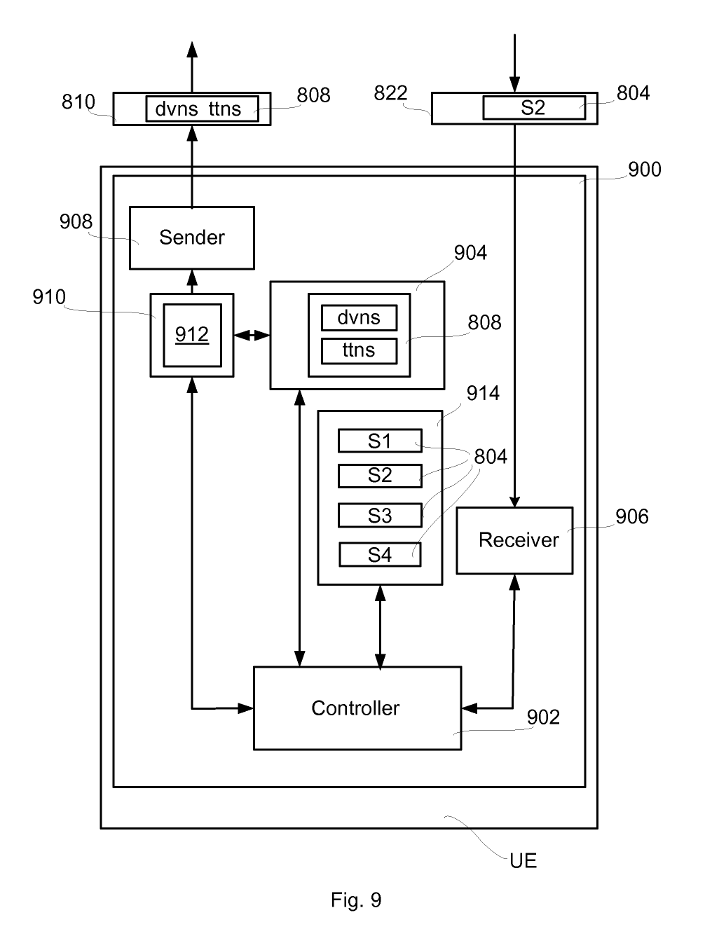

FIG. 9 is a block diagram illustrating a User Equipment UE comprising a module 900 adapted to support reconfiguration to a state S1, S2, . . . , of a Radio Resource Control, RRC, state machine in accordance with the method 600 described with reference to FIGS. 6A, 6B and in accordance with the method 601 described with reference to FIG. 7. It is assumed that the state of the state machine in the network and in the UE shall be set to the same state.

The module 900 comprises a number of functional blocks of which some are shown in FIG. 9 and some are omitted so as not to obscure the description with unnecessary detail. In FIG. 9 is depicted a UE device 900 comprising a receiver block 906, a sender block 908, a controller 902 and storage 904, a Radio Resource Control RRC state machine 914 and a message generator 910.

In the following description of the embodiments, a message indicating the end of a data session performed by the UE is denoted end-of-session message. Further, a message comprising information about the selected state is denoted reconfiguration order message.

The module 900 comprises a message generator 910 to generate an end-of-session message 810, wherein the message generator 910 comprises an insert module 912 configured to insert information 808 concerning the next data session in said end-of-session message 810. The insert module 912 is adapted to handle information 808 concerning the next data session. Said information indicates an expected time to next session, ttns, of the UE and/or information indicating an expected data volume of next session, dvns, of the UE. The values of the parameter ttns and/or parameter dvns are stored in the storage 904 from which the controller is configured to transfer said values to the message generator 910 and the insert module 912. The message generator 910 may be configured to generate a Signal Connection Release Indication Message as an end-of-session message 810 to the Radio Access Network, and the insert module 912 is configured to insert the ttns value and/or dvns value in said message before transmitting the message.

The module 900 further comprises a sender 908 to send said end-of-session message 810 to a node (see 16 in FIG. 1) in the RAN.

The receiver block 906 is adapted to receive from the Radio Access Network a reconfiguration order message 822 comprising information about the selected state S1, S2, . . . for reconfiguring the UE.

The controller 902 adapted to reconfigure the state 804 of the RRC state machine 914 the state S1, S2, . . . indicated by the reconfiguration information 804 in the reconfiguration order message 822. The UE may comprise other radio devices, processors and components, which are not shown in the figure. According to some embodiments, some elements or functional blocks of the module 900 may be common and shared by the UE and the module 900, such as the sender, receiver and controller.

The described embodiments of the device 800 and module 900 may be implemented in digital electronically circuitry, or in computer hardware, firmware, software, or in combinations of them. The apparatus may be implemented in a computer program product tangibly embodied in a machine readable storage device for execution by a programmable processor; and method steps may be performed by a programmable processor executing a program of instructions to perform functions by operating on input data and generating output.

The device 800 and module 900 may advantageously be implemented in one or more computer programs that are executable on a programmable system including at least one programmable processor coupled to receive data and instructions from, and to transmit data and instructions to, a data storage system, at least one input device, and at least one output device. Each computer program may be implemented in a high-level procedural or object-oriented programming language, or in assembly or machine language if desired; and in any case, the language may be a compiled or interpreted language.

Generally, a processor will receive instructions and data from a read-only memory and/or a random access memory. Storage devices suitable for tangibly embodying computer program instructions and data include all forms of non-volatile memory, including by way of example semiconductor memory devices, such as EPROM, EEPROM, and flash memory devices; magnetic disks such internal hard disks and removable disks; magneto-optical disks; and CD-ROM disks. Any of the foregoing may be supplemented by, or incorporated in, specially designed ASICs (Application Specific Integrated Circuits).

One example beneficial application is to machine-to-machine type of applications, e.g., a UE comprising the module, with a predictable traffic pattern, such as for example meters or sensors—reporting similar type of information, e.g., repetitively every minute, hour, day or month.

A number of non-limiting example embodiments have been described. It will be understood that various modifications may be made without departing from the scope of the claims. Therefore, other implementations are within the scope of the following claims.

### REFERENCES

[1] 3GPP TS 25.331 V10.0.0 (2010-06)
[2] 3GPP CR3483 on TS 25.331 (RP-081033)

1. A method in a Radio Access Network for supporting reconfiguration of a User Equipment UE to a state of a Radio Resource Control (RRC) state machine, the method comprising:
receiving information concerning the UE's next data session in a message indicating the end of a data session performed by the UE, wherein the information concerning the UE's next data session includes information indicating an expected time to the next session of the UE; and
selecting a state for the UE based on the information concerning the UE's next data session and in accordance with a selection rule set.

2. (canceled)

3. A method in a Radio Access Network for supporting reconfiguration of a User Equipment UE to a state of a Radio Resource Control (RRC) state machine, the method comprising:
receiving information concerning the UE's next data session in message indicating the end of a data session performed by the UE, wherein the information concerning the UE's next data session comprises information indicating an expected data volume of the next session of the UE; and
selecting state for the UE based on the information concerning the UE's next data session and in accordance with a selection rule set.

4. The method according to claim 1, wherein the selection rule set comprises one or more timer rules configured for state selection.

5. The method according to claim 3, wherein the selection rule set comprises one or more data volume rules configured for state selection.

6. The method according to claim 1 or 3, wherein a message comprising information about the selected state is generated and sent to the UE if a state reconfiguration for the UE is decided.

7. The method according to claim 1, wherein the method is performed in one or more nodes of the RAN.

8. A method for supporting reconfiguration of a User Equipment (UE) to a state of a Radio Resource Control (RRC) state machine, the method comprising:
generating a message indicating the end of a data session performed by the UE;
sending the message indicating the end of the UE data session to the Radio Access Network wherein the UE is residing;
wherein the generation of the message indicating the end of the UE data session comprises
inserting information concerning the UE's next data session in the message indicating the end of the UE data session, wherein the information concerning the UE's next data session includes information indicating an expected to the next session of the UE.

9. The method according to claim 8, comprising:
receiving from the Radio Access Network wherein the UE is residing information about the selected state for reconfiguring the UE;
reconfiguring the UE to the state indicated by the received information.

10. (canceled)

11. The method according to claim 8, wherein the information concerning the UE's next data session also comprises information indicating an expected data volume of next session of the UE.

12. A device in Radio Access Network, the device being configured for supporting reconfiguration of a User Equipment UE to a state of a Radio Resource Control (RRC) state machine, the device comprising:
a receiver to receive information concerning the UE's next data session in a message indicating the end of a data session performed by the UE, wherein the information concerning the UE's text data session includes information indicating an expected time to the next session of the UE; and
a selecting data processor module configured to select a state for the UE based on the information concerning the UE's next data session and in accordance with a selection rule set.

13. (canceled)

14. A device in Radio Access Network, the device being configured for supporting reconfiguration of a User Equipment UE to a state of a Radio Resource Control (RRC) state machine, the device comprising:
a receiver to receive information concerning the UE's next data session in a message indicating the end of data session performed bye the UE, wherein the information concerning the UE's next data session information indicating an expected data volume of next session of the UE; and
a selecting data processor module configured to select a state for the UE based on the information concerning the UE's next data session and in accordance with a selection rule set.

15. The device according to claim 12, wherein the selecting data processor module comprises the selection rule set involving one or more timer rules for state selection.

16. The device according to claim 14, wherein the selecting data processor module comprises the selection rule set involving one or more data volume rules for state selection.

17. The device according to claim 12, further comprising a sender module configured to generate and send a message comprising information about the selected state if a state reconfiguration for the UE is decided.

18. Electronic circuitry for an User Equipment (UE) configured to support reconfiguration to a state of a Radio Resource Control (RRC) state machine of the UE, the electronic circuitry comprising:
a message generator configured to generate a message indicating the end of a data session performed by the UE;
a sender configured to send said message indicating the end of the data session to a node of the Radio Access Network wherein the UE is residing;
wherein the message generator comprises:
an insert module configured to insert information concerning the UE's next data session in said message indicating the end a data session, wherein the information concerning the UE's next data session includes information indicating an expected time to the next session of the UE.

19. The electronic circuitry according to claim 18, further comprising:
a receiver configured to receive from a Radio Access Network information about the selected state for reconfiguring the UE, and
a controller configured to reconfigure the UE to the state indicated by the received information.

20. (canceled)

21. Electronic circuitry for an User Equipment (UE) configured to support reconfiguration to a state of a Radio Resource Control (RRC) state machine of the UE, the electronic circuit comprising:
a message generator configured to generate a message indicating the end of a data session performed by the UE;
a sender configured to send said message, indicating the end of data session to a node of the Radio Network wherein the UE is residing;
wherein the message generator comprises:
insert module configured to insert information concerning the UE's next data session in said message indicating the end of a data session, wherein the information concerning the UE's next data session includes information indicating an expected data volume of next session of the UE.

22. A User Equipment comprising the electronic circuitry according to claim 18.

23. A User Equipment comprising the electronic circuitry according to claim 21.

24. The method in claim 1, wherein the information concerning the UE's next data session also comprises information indicating an expected data volume of the next session of the UE.

25. The device in claim 12, wherein the information concerning the UE's next data session also comprises information indicating an expected data volume of the next session of the UE.

26. The electronic circuitry in claim 12, wherein the information concerning the UE's next data session also comprises information indicating an expected data volume of the next session of the UE.
